(19) United States
(12) Patent Application Publication
(10) Pub. No.: US 2005/0048851 A1
(43) Pub. Date: Mar. 3, 2005

(54) Electrical terminal and method for manufacturing same

(76) Inventors: Masao Okita, Furukawa (JP); Hsiu-Yuan Hsu, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/934,848

(22) Filed: Sep. 3, 2004

(30) Foreign Application Priority Data
Sep. 3, 2003 (TW) 92124286

(51) Int. Cl. H01R 11/22

(52) U.S. Cl. 439/851; 29/874

(57) ABSTRACT

An electrical terminal is provided with a nickel-plating layer (22), a silver-plating layer (24) disposed on the nickel-plating layer and a gold-plating layer (26) disposed on the silver-plating layer. The thickness of the silver-plating layer is 3-6 times of the nickel-plating layer and 3-6 times of the gold-plating layer. A method for manufacturing the terminal comprises steps as following: stamping step (51) for providing a general terminal shape from a conductive base material; forming step (52) for providing the terminal normal configuration; nickel plating step (53) for providing nickel-plating layer on the terminal; silver plating step (54) providing silver-plating layer on the nickel-plating layer; gold plating step (55) providing gold-plating layer on the silver-plating layer; and splitting step (56) for cutting the terminal from the strip.

### BACKGROUND OF THE INVENTION

1. Field of the Invention

The present invention relates to an electrical terminal for electrically connecting an integrated circuit (IC) to a printed circuit board (PCB), and especially, to method for manufacturing such terminal.

2. Description of the Prior Art

Generally, terminals used in a Ball Grid Array (BGA) or Pin Grid Array (PGA) IC socket are provided with a gold-plating layer disposed on a contacting portion thereof for assuring excellent electric performance. Conventionally, the gold-plating layer is provided on the contacting portion after a nickel-plating layer is provided thereon. Such a method is disclosed in U.S. Pat. Nos. 5,307,562 and 6,451,449. In these literatures, the gold-plating layer is directly disposed on the nickel-plating layer for ensuring favorable conductivity and inoxidizability of the contacting portion of the terminal. However, the method described above cannot ensure frictional resistance and corrosion stability of the contacting portion.

The above-described disadvantages are more obvious while the terminals are used in a burn-in socket. A burn-in socket is required to be used continually in high temperature and high-pressure environment, which requires the terminals to be provided with excellent frictional resistance and corrosion stability.

Hence, a new terminal and method for manufacturing said terminal which overcomes the above-described disadvantages is desired.

### SUMMARY OF THE INVENTION

Accordingly, a primary object of the present invention is to provide an electrical terminal having excellent frictional resistance and corrosion stability.

Another object of the present invention is to provide a method for manufacturing an electrical terminal having excellent frictional resistance and corrosion stability.

In order to achieve the abovementioned objects, an electrical terminal in accordance with a preferred embodiment of the present invention is provided with a nickel-plating layer, a silver-plating layer disposed on the nickel-plating layer and a gold-plating layer disposed on the silver-plating layer. The thickness of the silver-plating layer is 3-6 times of that of the nickel-plating layer and 3-6 times of that of the gold-plating layer. A method for manufacturing the terminal comprises steps as following: stamping step for providing a general terminal shape from a conductive base material; forming step for providing the terminal normal configuration; nickel plating step for providing nickel-plating layer on the terminal; silver plating step providing silver-plating layer on the nickel-plating layer; gold plating step providing gold plating layer on the silver-plating layer; and splitting step for cutting the terminal from the strip.

Other objects, advantages and novel features of the present invention will become more apparent from the following detailed description when taken in conjunction with the accompanying drawings, in which:

### BRIEF DESCRIPTION OF THE DRAWINGS

FIG. 1 is an isometric view of an electrical terminal in accordance with the preferred embodiment of the present invention, showing a pin of an IC connecting to a contacting portion thereof;

FIG. 2 is a sketch of plate layers disposed on the contacting portion; and

FIG. 3 is a block diagram for the method for manufacturing the electrical terminal.

### DESCRIPTION OF THE PREFERRED EMBODIMENT

Reference will now be made to the drawing figures to describe the present invention in detail.

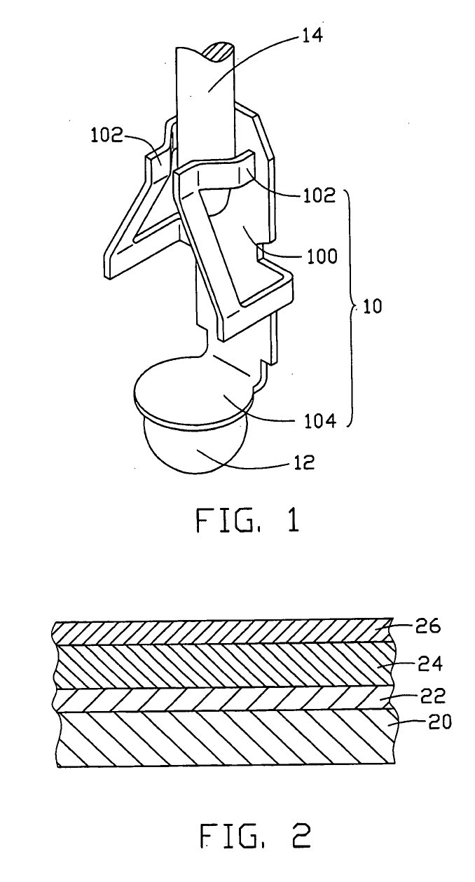

Referring to FIGS. 1 and 2, an electrical terminal 10 in accordance with the preferred embodiment of the present invention is used for electrically connecting a pin 14 of an IC (not shown) to a PCB (not shown). The terminal 10 is formed from conductive base material 20 and comprises a base portion 100, a contacting portion 102 extending from the base portion 100, a solder portion 104 for electrically connecting to the PCB. In the preferred embodiment, the solder portion 104 is connected to the PCB via a solder ball 12. In the using process, especially while the terminal 10 is used in a burn-in socket, the contacting portion 102 is required to contact the pin 14 of the IC frequently. Therefore, the friction between the contacting portion 102 and the pin 14 is also frequent. For ensuring fine performance, the contacting portion 102 is required to be provided with excellent frictional resistance and corrosion stability.

In order to ensure excellent frictional resistance and corrosion stability, the contacting portion 102 of the terminal 10 is generally provided with several plate layers thereon and the remainder portion of the terminal 10 is only provided with nickel-plating layer. As illustrated in FIG. 2, the contacting portion 102 is provided with a nickel-plating layer 22 disposed on the base material 20, a silver-plating layer 24 disposed on the nickel-plating layer 22 and a gold-plating layer 26 disposed on the silver-plating layer 24. The nickel-plating layer 22 enables minimal contact impedance and fine corrosion stability of the contacting portion 102. The silver-plating layer 24 enables fine frictional resistance and corrosion stability of the contacting portion 102. And the gold-plating layer 26 enables excellent conductivity of the contacting portion 102. Compared with the conventional terminal, the terminal 10 of the present invention is provided with a serviceable silver-plating layer 24, which enhances frictional resistance and corrosion stability of the contacting portion 102.

According to different applications of the terminal 10, the thickness of each plate layer is variable. In order to obtain excellent performance, the thickness of the silver-plating layer 24 is 3-6 times of that of the nickel-plating layer 22 and 3-6 times of that of the gold-plating layer 26.

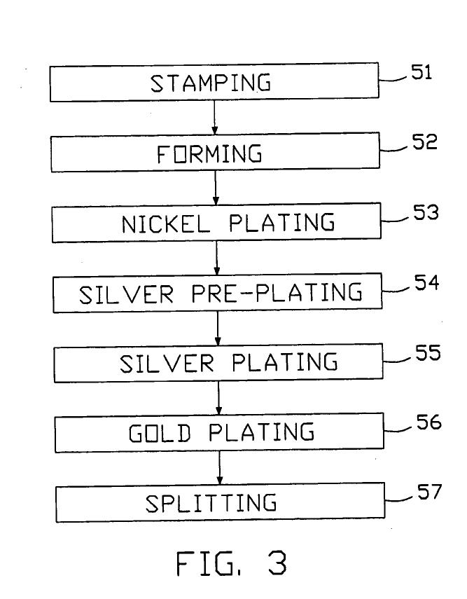

FIG. 3 illustrates a flow chart of a method for manufacturing the terminal 10. The method comprises steps as following: stamping step 51 for providing a general terminal shape from a conductive base material (terminal strip); forming step 52 for providing the terminal normal configuration; nickel plating step 53 for providing nickel-plating layer on the terminal; silver pre-plating step 54; silver plating step 55 providing silver-plating layer on the pre-silver-plate layer; gold plating step 56 providing gold plating layer on the silver-plating layer; and splitting step 57 for cutting the terminal from the strip. In the preferred embodiment, the silver pre-plating step 54 is provided to enable fine plating effect.

While the present invention has been described with reference to a specific embodiment, the description is illustrative of the invention and is not to be construed as limiting the invention. Various modifications to the present invention can be made to the preferred embodiment by those skilled in the art without departing from the true spirit and scope of the invention as defined by the appended claims.

1. An electrical terminal for electrically connecting an integrated circuit (IC) to a printed circuit board (PCB) comprising:
a base portion;
a contacting portion extending from the base portion;
a solder portion extending from the base portion for connecting to the PCB; wherein,
the contacting portion is provided with a nickel-plating layer, a wear-resistant layer disposed on the nickel-plating layer and a gold-plating layer disposed on the wear-resistant layer, wherein said wear-resistant layer is different from said nickel-plating layer and said gold-plating layer.

2. The electrical terminal as described in claim 1, wherein said wear-resistant layer is a silver-plating layer.

3. The electrical terminal as described in claim 2, wherein the thickness of the silver-plating layer is 3-6 times of that of the nickel-plating layer.

4. The electrical terminal as described in claim 2, wherein the thickness of the silver-plating layer is 3-6 times of that of the gold-plating layer.

5. An electrical terminal stamped from a conductive strip comprising conductive base material, nickel-plating layer disposed on the conductive base material, silver plating layer disposed on the nickel-plating layer and gold-plating layer disposed on the silver-plating layer.

6. The electrical terminal as described in claim 5, wherein the terminal comprises a base portion, a contacting portion extending from the base portion and a solder portion extending from the base portion.

7. The electrical terminal as described in claim 6, wherein the plate layers are disposed on the contacting portion.

8. The electrical terminal as described in claim 6, wherein the thickness of the silver-plating layer is 3-6 times of that of the nickel-plating layer.

9. The electrical terminal as described in claim 6, wherein the thickness of the silver-plating layer is 3-6 times of that of the gold-plating layer.

10. A method for manufacturing an electrical terminal comprising following steps:
(a) stamping step for providing a general terminal shape from a conductive strip;
(b) forming step for providing the terminal normal configuration;
(c) nickel plating step for providing nickel-plating layer on the terminal;
(d) silver plating step providing silver-plating layer on the nickel-plating layer; and
(e) gold plating step providing gold-plating layer on the silver-plating layer.

11. The method as described in claim 10 further comprising silver pre-plating step prior to the silver plating step.

12. The method as described in claim 10 further comprising splitting step for cutting the terminal from the strip.
